(19) United States
(12) Patent Application Publication
(10) Pub. No.: US 2002/0141428 A1
(43) Pub. Date: Oct. 3, 2002

(54) Line card and method for supporting a plurality of telecommunication services

(76) Inventor: Carl Robert Posthuma, Wheaton, IL (US)

Correspondence Address: GROSSMAN, PATTI & BRILL, 300 W. WASHINGTON ST. #1200, CHICAGO, IL, 60606-2002, US

(21) Appl. No.: 09/821,962

(22) Filed: Mar. 30, 2001

(51) Int. Cl. H04L 12/28

(52) U.S. Cl. 370/419; 375/222

(57) ABSTRACT

A line card and method is provided which supports a plurality of telecommunication services including xDSL telecommunication service, ISDN telecommunication service, PPM service, P-Phone service, POTS service, and DAML service.

### BACKGROUND

The present invention relates generally to telecommunication systems that provide data and voice communications and in particular to a line card and method which supports a plurality of telecommunication services.

Strong demand requires telecommunication service providers to supply a variety of telecommunication services to their subscribers. Digital Subscriber Line (DSL) service, Integrated Service Digital Network (ISDN) service, Digital Added Mainline (DAML), Periodic Pulse Metering (PPM), or Teletax Service, P-Phone, and Plain Old Telephone Service (POTS) are common offerings.

Many telecommunication service providers provide a combination of these services to subscribers. Often times, the combination of services is provided over the same line. For example, xDSL (where the “x” stands for a particular type of DSL service, such as ADSL, ADSL lite, VDSL, etc.) signals can be transmitted with underlying POTS, POTS with PPM, and ISDN signals.

To remain competitive, many telecommunications service providers find it necessary to offer subscribers xDSL service with all of the above underlying services. Providing multiple underlying services, however, requires many different types of equipment. For example, one type of line card is necessary to provide xDSL with underlying POTS, and a second type of line card is necessary to provide xDSL with underlying ISDN. Consequently, a service provider that offers xDSL with underlying POTS and xDSL with underlying ISDN must use multiple line cards. This increases the cost and complexity of providing these services.

Current line cards are also not optimally configured to provide multiple services. For example, providers generally use the type of line card that is configured for ADSL with underlying 4B3T ISDN service to provide ADSL with concurrent POTS with PPM service. This practice wastes valuable bandwidth and reduces the robustness of the telecommunication network.

Accordingly, there is a need in the art for a line card and method for supporting a plurality of telecommunication services.

### SUMMARY

Pursuant to the present invention shortcomings of the existing art are overcome and additional advantages are provided through the provision of a line card and method for supporting multiple telecommunication services.

The invention in one example comprises a line card for a telecommunication system. The line card comprises a multiple mode circuit that supports a plurality of telecommunication services including xDSL telecommunication service, ISDN telecommunication service, and POTS service.

In another example the invention encompasses a line card for a telecommunication system. The line card comprises a multiple mode circuit that supports a plurality of telecommunication services including xDSL telecommunication services, POTS service and POTS with PPM service.

In a further example the invention encompasses a line card for a telecommunication system. The line card comprises a multiple mode circuit that supports xDSL telecommunication service, ISDN telecommunication service, POTS telecommunication service, and POTS with PPM telecommunication service.

In still another example the invention encompasses a method for supporting multiple telecommunication services in a line card. The method comprises selecting either a first operational mode or a second operational mode for the line card wherein the first operational mode provides substantial concomitant and operation of a xDSL telecommunication service and POTS service and the second operational mode provides substantial concomitant operation of xDSL telecommunication service and POTS with PPM service. If the first operational mode is selected xDSL telecommunication signals and POTS signals are separated and processed. If the second operational mode is selected xDSL telecommunication signals and POTS with PPM signals are separated and processed.

In a further example the invention encompasses a method for supporting multiple telecommunication services in a line card. A first operational mode, or a second operational mode, are selected wherein the first operational mode provides support for substantial concomitant operation of xDSL telecommunication service and POTS service and the second operational mode provides support for substantial concomitant operation of xDSL telecommunication service and ISDN telecommunication service. If the first operational mode is selected, xDSL telecommunication signals and POTS signals are separated and processed. If the second operational mode is selected, xDSL telecommunication signals and ISDN signals are separated and processed.

In another example the invention encompasses a line card. In the line card, a plurality of xDSL telecommunication services are supported by a first interface. A plurality of underlying services (USVs) are supported by a second interface. A controller configures the first interface for one of the plurality of xDSL telecommunication services and configures the second interface for one of the plurality of USVs.

These and other features and advantages of the present invention will become apparent from the following detailed description and accompanying drawings and the appended claims.

### BRIEF DESCRIPTION OF THE DRAWINGS

FIG. 1 is a block diagram of a communication system employing a line card which supports a plurality of telecommunication services.

FIG. 2 is a more detailed block diagram of the communication system shown in FIG. 1.

FIG. 3 is a block diagram of the communication system as shown in FIG. 1 further including external devices.

FIG. 4 is a block diagram of a central office configured to achieve the splitting of telecommunications signals in the high voltage domain.

FIG. 5 is a block diagram of a central office configured to achieve the splitting of telecommunications signals in the digital domain.

### DETAILED DESCRIPTION

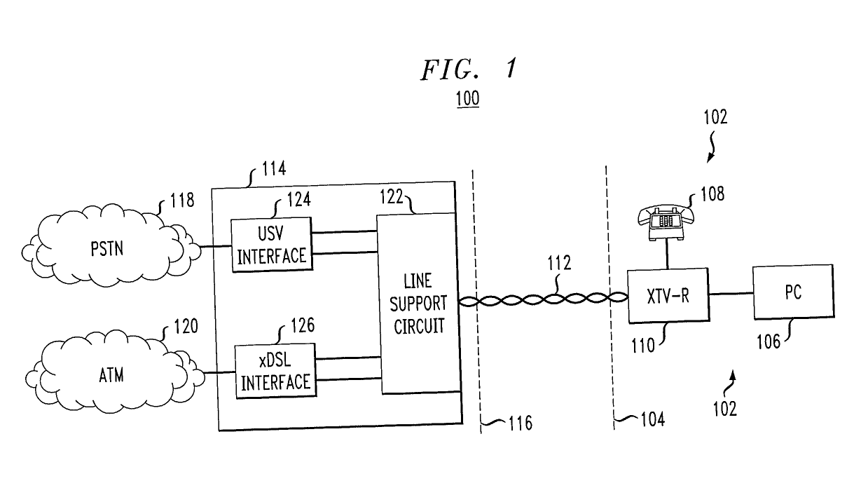

FIG. 1 is a generic block diagram of a communication system 100. Communication system 100 in one example is a circuit pack or a line card. In one example the line card supports xDSL services (e.g., ADSL, ADSL Lite, VDSL, etc.) with an underlying service (USV). Examples of an USV are POTS, POTS with PPM (hereinafter referred to as “PPM), ISDN, P-Phone and DAML. In one example system 100 supports multiple versions of the USV. For example, system can support 12 kHz PPM, 16 kHz PPM, 2B1Q ISDN, and/or 4B3T ISDN.

Communication system 100 comprises customer premises equipment (CPE) 102, which is located right of dashed line 104. CPE 102 in one example comprises a personal computer (PC) 106, and a telephone 108, such as a POTS telephone or an ISDN telephone. Telephone 108 is connected to a subscriber terminating unit (xTU-R) 110. The xTU-R 110 provides an interface between incoming and outgoing communications over a subscriber line 112, such as a twisted wire pair or loop. As will be appreciated by those skilled in the art, the specific CPE 102 shown and described herein is for exemplary purposes only. Other devices also may be part of the CPE 102.

A central office (CO) 114, which is shown generally left of dashed line 116, comprises various terminating equipment that interconnects the CPE 102 to a public switched telephone network (PSTN) 118 and an asynchronous transfer mode (ATM) network 120. Alternatively, network 120 could be an IP backbone.

CO 114 in one example comprises line support circuit 122, a USV interface 124 and an xDSL interface 126. The USV interface 124 connects CO 114 with the PSTN 118. USV interface 124 in one example supports POTS, ISDN, PPM, P-Phone, and/or DAML. In another example, USV interface 124 supports multiple versions of each service (e.g., 12 kHz PPM, 16 kHz PPM, 2B1Q ISDN, 4B3T ISDN, etc.). xDSL interface 126 connects the CO 114 with the ATM network 120. Line support circuit 122 interfaces the respective USV and xDSL interfaces 124 and 126 with subscriber line 112. Communication system 100 therefore provides a combination of a xDSL service with an USV between the CPE 102 and networks 118, 120. Alternatively, communication system 100 could provide only xDSL service between the CPE 102 and the ATM network 120 or only USVs between CPE 102 and PSTN 118.

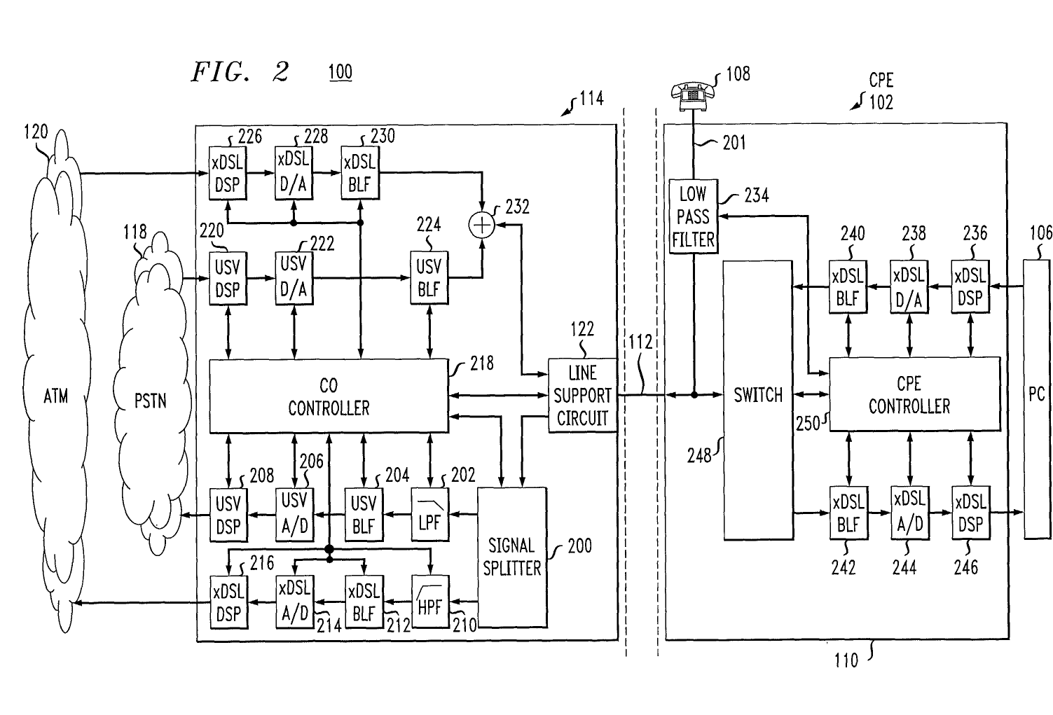

Referring to FIG. 2, a detailed exemplary block diagram of CO 114 and xTU-R 110 is shown. In the example of FIG. 2, communication system 100 separates xDSL signals from the signals of an USV through employment of filtering in the low voltage domain. In one example the filtering in the low voltage domain is conducted as described in U.S. Pat. No. 6,144,659, to Nye et al., which is entitled Telecommunication Equipment Support of High Speed Data Services and is hereby incorporated by reference. With respect to CO 114, USV interface 124 in one example comprises a transmit USV branch, a receive USV branch, a signal splitter 200, a CO controller 218, and a summer 232 to provide an USV between PSTN 118 and CPE 102. xDSL interface 126 in one example comprises a transmit xDSL branch, a receive xDSL branch, a signal splitter 200, the CO controller 218 and the summer 232 to provide xDSL services between the ATM network 120 and the CPE 102.

The receive USV branch in one example comprises receive low pass filter (LPF) 202, receive USV band limiting filter (BLF) 204, a receive USV analog-to-digital converter (AID) 206 and a receive USV digital signal processor (DSP) 208. The transmit USV branch in one example comprises a transmit USV DSP 220, a transmit USV D/A converter 222, and a transmit USV BLF 224.

The receive xDSL branch in one example comprises receive high pass filter (HPF) 210, receive xDSL band limiting filter (BLF) 212, receive xDSL analog-to-digital converter (A/D) 214 and receive xDSL digital signal processor (DSP) 216. The transmit xDSL branch in one example comprises transmit xDSL DSP 226, transmit xDSL D/A converter 228 and transmit xDSL BLF 230.

Still referring to FIG. 2, in one example, communication signals are received at line support circuit 122 from CPE 102. The communication signals in one example comprise xDSL signals, POTS signals, ISDN signals, P-Phone signals, and/or DAML signals. As was stated earlier, the xDSL signals in one example comprise ADSL, ADSL lite, or VDSL signals and the ISDN signals comprise either 2B1Q or 4B3T ISDN signals. Line support circuit 122 transmits the communication signals to signal splitter 200. Signal splitter 200 provides the received communication signals to the receive USV branch and the receive xDSL branch. The receive USV branch extracts USV signals, if present, from the received communication signals and provides them to PSTN 118. The receive xDSL branch extracts the xDSL signals, if present, from the received communication signals and provides them to the ATM network 120.

Referring further to FIG. 2, in one example, communication signals are received at CO 114 from PSTN 118 and/or ATM network 120. The communications signals from PSTN 118 in one example comprise POTS, PPM (e.g., 12 kHz PPM, 16 kHz PPM, etc.), ISDN (e.g., 2B1Q ISDN, 4B3T ISDN), P-Phone, and/or DAML signals. The communications signals from ATM network 120 in one example comprise xDSL signals (e.g., ADSL, ADSL lite, VDSL, etc). The communication signals received from the PSTN 118 are processed by the transmit POTS/ISDN/PPM branch. The communication signals received from the ATM network 120 are processed by the transmit xDSL branch. The communication signals processed by the transmit USV branch and the transmit xDSL branch are summed by a summer 232 and provided to line support circuit 122 for transmission to CPE 102 over the line 112.

Line support circuit 122, the components of the receive USV branch, the components of the receive xDSL branch, the components of the transmit USV branch, the components of transmit xDSL branch, and the signal splitter 200 are controlled by the central office (CO) controller 218. Since the basic operation of the components in the system 100 are known in the art, conventional components and circuits have, for the most part, been illustrated in the drawings by readily understandable block representations and schematic diagrams, which show only those specific details that are pertinent to the present invention. These block representations and schematic diagrams have been employed in order not to obscure the disclosure with structural details which will be readily apparent to those skilled in the art having the benefit of the description herein.

At CPE 102, communication signals are transmitted to/from telephone 108 over line 201. The signals in one example comprise POTS, POTS with PPM, or ISDN signals. In another example, the signals are provided to telephone 108 via an optional low pass filter or splitter. This filter or splitter in one example filters out a xDSL signal to prevent interference with phone traffic. Also at CPE 102, signals are transmitted to/from PC 106 over a CPE transmit branch and a CPE receive branch. The signals in one example comprise xDSL signals (e.g., ADSL, ADSL lite, VDSL, etc.). The CPE transmit branch comprises CPE xDSL DSP 236, CPE xDSL D/A converter 238 and CPE xDSL BLF 240. The CPE receive branch is comprised of CPE xDSL BLF 242, CPE xDSL A/D converter 244 and CPE xDSL DSP 246. A hybrid 248 interconnects the CPE receive and transmit branches with the subscriber line 112. The optional low pass filter 234, the CPE transmit branch, the CPE receive branch and the hybrid 248 are controlled by a CPE controller 250.

A further description of operation of the communication system 100 in accordance with the present invention will now be described with reference to FIG. 2. The present invention operates in various configurations depending upon the communication signal formats being employed. The services supported by the present invention can be selected manually or may be selected automatically and dynamically, as described more fully below.

In accordance with one aspect of the present invention, xDSL services, POTS services, POTS with PPM services, ISDN services, P-Phone services, and/or DAML services are supported from a single line card, or circuit pack. These services may consist of, for example, ADSL, ADSL lite or VDSL in combination with, for example, POTS, POTS with PPM, ISDN, P-Phone, and DAML. The underlying POTS with PPM service could include either 12 kHz or 16 kHz PPM service. The underlying ISDN service could include either 2B1Q or 4B3T ISDN service.

In a configuration wherein line card 114 supports underlying P Phone, telephone 108 comprises a P-Phone. A P-Phone uses an 8 kHz tone to communicate with the PSTN to offer some ISDN like services on an analog phone. It should also be noted that when line card 114 is configured to support underlying DAML service, telephone 108 would be replaced with a DAML device. The DAML device operates at frequencies similar to the ISDN frequencies but higher than those used by normal POTS or PPM service.

A description of system 100 when it is configured for a particular operational mode is now provided. When system is configured for an operational mode, signals are transmitted between CO 114 and CPE 102 over subscriber line 112 via line support circuit 122, in a known manner and under the control of the CO controller 218, to support the signals. CO controller 218 configures the components of the transmit and receive branch of the particular type of signal the line card is configured for. For instance, if the line card is to support ADSL with POTS, the transmit and receive xDSL branch components are configured for ADSL. Likewise, the transmit USV branch and the components of the receive USV branch are configured for POTS. Similarly, if ADSL lite and 4B3T ISDN service are to be supported, controller configures the transmit and receive xDSL branches for ADSL lite, and configures the transmit USV branch and the receive USV branch for 4B3T ISDN. In a similar manner, all of the potential operating modes discussed above (e.g., 12 kHz PPM, 16 kHz PPM, Pphone, DAML, VDSL, 2BIQ ISDN, etc.) are supported.

Signal splitter 200 is activated to split communication signals received from CPE 102 over the subscriber line 112 into two signals, a USV branch signal and a xDSL branch signal. In one example signal splitter 200 splits or filters communication signals in the low voltage domain. In another example, communication signals are split in the high voltage domain. In a further example, communications signals are split in the digital domain. As was stated above, FIG. 2 describes signal splitting in the low voltage domain. Signal splitting in the high voltage domain and the digital domain will be discussed herein. In the USV branch receive USV LPF 202 removes any high frequency components in the USV branch signal, such as xDSL signals. This essentially separates the xDSL signals from any USV signals in the USV branch signal. Receive USV LPF 202 may be set at a cutoff frequency. For a POTS signal, an exemplary cutoff frequency could be approximately 16 kHz. For an ISDN signal, the receive USV LPF 202 could be set at an exemplary cutoff frequency of approximately 100 kHz. For a PPM signal, an exemplary cutoff frequency could be 25-35 kHz. For P-Phone, an exemplary cutoff frequency could be 20-25 kHz. For DAML, an exemplary cutoff frequency could be 30-100 kHz. It should be noted, however, that the cutoff frequencies provided above are strictly for exemplary purposes only. Other cutoff frequencies could be used depending on the type of equipment used and/or the implementation of communication system 100. After filtering by LPF 202, the filtered USV branch signal is further filtered by the receive USV BLF 204.

Filters 202 and 204 may be tuned in any number of known manners, since the particular tuning of the filters 202 and 204 is not important except for being appropriate for extracting POTS, DAML, P-Phone and/or ISDN signals from the USV branch signal.

After filtering, the USV signal, is then converted into a digital USV signal. The digital USV signal is then processed by receive USV DSP 208 and sent to PSTN 118. Receive USV DSP 208 may perform any number of known digital signal processing techniques on the digital USV signal, such as for example, echo cancellation, voice monitoring and the like. The processed digital signal is then transmitted over the PSTN 118.

As for the xDSL signal that is transmitted concomitant with the USV signal. Signal splitter 200, as previously indicated, splits the received communication signal into a xDSL branch signal. The xDSL branch signal is provided to the receive xDSL HPF 210 which blocks the lower frequency USV signals and passes the higher frequency xDSL signals. Receive xDSL HPF 210 could have, for example, the exemplary cutoff frequencies listed above, with respect to LPF 202, for the various underlying services. The xDSL signal is then provided to receive xDSL BLF 212 which has a frequency bandwidth controlled by the CO controller 218. CO controller 218 adjusts the frequency bandwidth depending upon which type of xDSL services are being received. For example, from CPE 102 to the CO 114, or in the “upstream” direction, ADSL and ADSL lite would include signals in the range of approximately 26 kHz to 134 kHz. For VDSL, several bandplans including the 997 and 998 bandplans could be chosen. The frequency range of the receive xDSL BLF 212 may be set for any appropriate service. The xDSL signal of the desired service is provided to the receive xDSL A/D converter 214 and the receive xDSL DSP 216 before being transmitted to the ATM network 120. The CO controller 218 may provide, or download, the proper code to the receive xDSL DSP 216 for the xDSL service being supported. Alternatively, a number of codes for different xDSL services may be resident in the receive xDSL DSP 216 and the CO controller 218 may select the proper code to execute.

In accordance with one example of the present invention, a line card may support one or a plurality of POTS, PPM, DAML, P-Phone, and/or ISDN services, as discussed above, and one of a plurality of xDSL services. By adjusting the frequency range of the receive USV BLF 204 and xDSL BLF 212, different xDSL services and USVs may be supported. CO controller 218 controls the frequency range of receive USV BLF 204 and xDSL BLF 212 to support the appropriate service. CO controller 218 may be preprogrammed to support a particular service or set of services. Although the system supports PPM, PPM is not discussed with respect to the receive branches. This is because, as is well known, PPM signals are typically only transmitted downstream (from PSTN 118 to CPE 102). PPM will be discussed below in connection with downstream operation of system. CO controller 218 may dynamically adjust the frequency range of receive xDSL BLF 212. CO controller 218 could sample information received in communication signals received from CPE 102 to determine which POTS, ISDN, P-Phone, DAML, and xDSL services should be supported and thus, determine the appropriate frequency range of the USV BLF 204 and the xDSL BLF 212. For example, CO controller 218 may access handshake information, such as contained in the G.990 series of specifications from the International Telecommunications Union, indicating which xDSL service will be used. CO controller 218 would then set the frequency range of xDSL BLF 212 based on the information received in the handshake. Based on which xDSL service was identified, CO controller 218 would download the appropriate code to xDSL BLF 212 to set the desired frequency range Via either handshake information or provisioned information from PSTN 118, the USV components are set to the desired service and filter frequency ranges.

For USV signals traveling downstream (from PSTN 118 to CPE 102), the signals are processed by transmit USV DSP 220 which is controlled by the CO controller 218 and then converted to an analog USV signal by transmit USV D/A converter 222. The analog signal is filtered by transmit USV BLF 224 (with a frequency range controlled by CO controller 218) and then combined with any xDSL signals being transmitted by summer 232. This combined signal is then transmitted by line support circuit 122 to CPE 102. CO controller 218 controls the frequency range of the transmit USV BLF 224 in a manner similar to that described above with respect to the receive USV BLF 212. Additionally, CO controller 218 also controls the operation, via code, of transmit USV DSP 220 as described above with respect to receive USV DSP 216.

For xDSL signals traveling downstream (from the ATM network 120 to CPE 102), the xDSL signals are processed by transmit xDSL DSP 226 which is controlled by CO controller 218 and then converted to an analog xDSL signal by transmit xDSL D/A converter 228. The analog xDSL signal is filtered by transmit xDSL BLF 230 (whose frequency range is controlled by CO controller 218) and then combined with any POTS signals being transmitted by summer 232. This combined signal is then transmitted by line support circuit 122 over subscriber line 112 to CPE 102. CO controller 218 controls the frequency range of transmit xDSL BLF 230 in a manner similar to that described above with respect to receive xDSL BLF 212. Additionally, CO controller 218 also controls the operation, via code, of transmit xDSL DSP 226 as described above with respect to receive xDSL DSP 216.

In accordance with the present invention, switching between operating configurations may be accomplished in a number of manners. As noted above, CO controller 218 may switch operating modes based on information, or an order, received from CPE 102. For example, a subscriber may have placed a POTS call and concomitantly be surfing the Internet using a first xDSL service such as ADSL. The subscriber terminates the POTS call and decides to change the Internet connection from the first xDSL service to a second xDSL service, such as VDSL. The subscriber, or CPE 102 then sends a reconfigure signal to CO 114 requesting the change in operating mode. As noted above, the reconfigure signal may be sent as a direct message or in a message channel of ATM or other layer. In the middle of a communication session, the reconfigure signal may be sent in the handshake format discussed above. Those skilled in the art will readily appreciate that these examples of methods for providing instructions to change the operating mode of the line card 100 are for illustration only, and any method may be employed in accordance with the present invention so long as the line card 100 receives an order to change its configuration. In response to the request to reconfigure, the CO controller 218 adjusts the appropriate components of the line card 100.

Additionally, CO controller 218 monitors substantially all of the components of the line card 100 and based on operation of the components may be programmed to automatically change the operating mode. For example, CO controller 218 may detect that some signals require a larger bandwidth than was originally provided. CO controller 218 may then instruct BLFs 212 and 230 to increase their frequency ranges. CO controller 218 thus comprises an automatic mode circuit for substantially automatically determining which operating mode is being supported, or for changing operating modes based on a predetermined criteria.

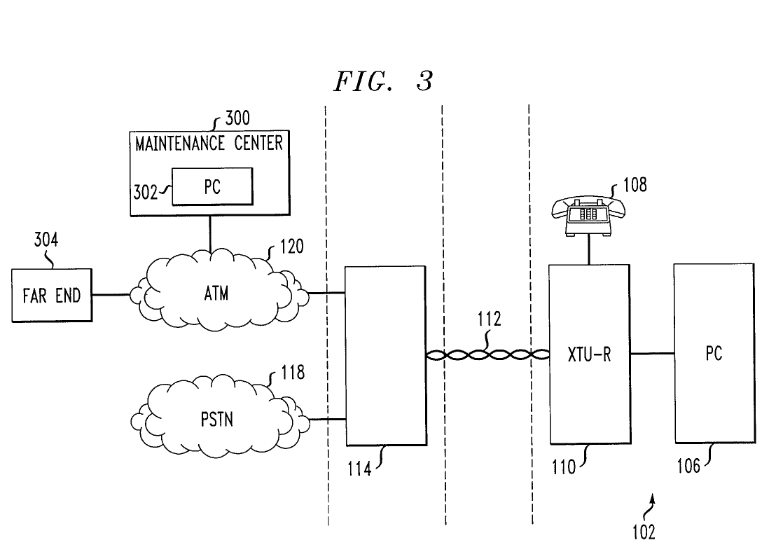

As one of ordinary skill in the art would understand, some form of hybrid 2 wire to 4 wire conversion and cancellation techniques, and some form of setting termination impedances would necessarily also take place in CO 114. In general the POTS, POTS with PPM, P-Phone, DAML and ISDN services are provisioned via PSTN 118 as described in FIG. 3 below.

One example of a method for changing operating modes in accordance with one example of the present invention is illustrated in FIG. 3. A maintenance center 300 including a computing device, such as PC 302, may provide instructions to the CO controller 218 to change operating modes through the ATM network 120. Alternatively, or additionally, a far end device 304, or system, may instruct the CO controller 218 to change operating modes. The maintenance center 300 and the far end device 304 may desire a change in operating mode due to any number of factors including network load, device capabilities, service contracts and the like. The maintenance center 300, the far end device 304 and the CPE 102 are all external devices which are capable of indicating to CO controller 218 that a change in the operating mode, or services, is desired. Switches and maintenance/provisioning centers in PSTN 118 can also be used to send messages to controller 218. These are generally used to control the POTS, PPM, DAML, and ISDN services.

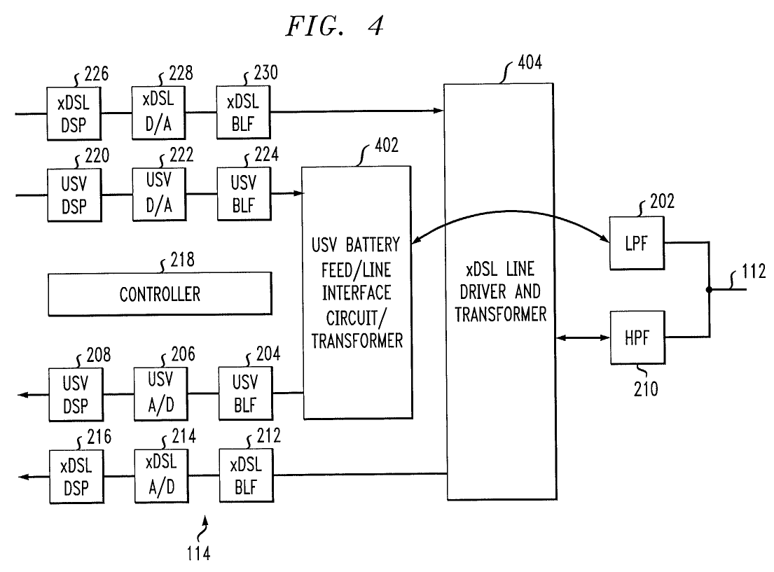

Referring to FIG. 4, in one example, system 100 can be alternatively configured such that the signal splitting, which was described above as being performed by signal splitter 200 in the low voltage domain, is instead performed in the high voltage domain. FIG. 4 depicts an example of CO 114 as it would be configured to perform signal splitting this manner. The example shown in FIG. 4 does not contain line support circuit 122 and signal splitter 200. Instead, LPF 202, and HPF 210 are coupled directly to line 112. Moreover, LPF 202, receive USV branch, and transmit USV branch are coupled to USV Battery Feed/Line Interface Circuit/Transformer 402. Meanwhile, HPF 210, transmit xDSL branch, and receive xDSL branch are coupled to xDSL Line Driver and Transformer 404. The LPF 202 filters out the xDSL signal and sends only the USV signals to the USV circuit 402. HPF 210 filters out the USV signals and sends only the xDSL signal to the xDSL Line Driver and Transformer 404. Depending upon the services that are being provided, the components in USV Battery Feed/Line Interface Circuit/Transformer 402 and xDSL Line Driver and Transformer 404 are switched into or out of the circuits as controlled from CO controller 218. xDSL Line Driver and transformer circuit 404 transmits to, and receives from, HPF 210 an xDSL signal. In one example, there are components in xDSL Line Driver and transformer circuit 404 that may require switching in or out during different modes of operation. USV Battery Feed/Line Interface Circuit/Transformer 402 can be one of or a combination of Battery Feed/Line Interface Circuits or Transformer circuits. USV Battery Feed/Line Interface Circuit/Transformer 402 transmits signals to, and receives signals from, LPF 202. In one example, there are components in USV Battery Feed/Line Interface Circuit/Transformer 402 that may require switching in or out during different modes of operation. The remaining elements operate in the manner described above with respect to FIG. 2.

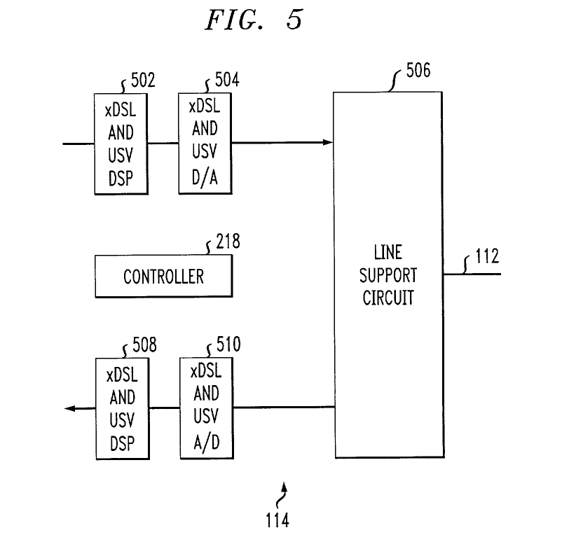

Referring to FIG. 5, in a further example, system 100 is configured such that the signal splitting is performed in the digital domain. FIG. 5 depicts an example of CO 114 as it would be configured to operate in this manner. In FIG. 5, CO 114 only comprises a xDSL and USV DSP 502, xDSL and USV D/A 504, Line Support Circuit 506, xDSL and USV DSP 508, xDSL and USV A/D 510, and CO controller 218. In the example shown in FIG. 5, filtering and signal separation is performed in the digital domain by xDSL and USV DSP 502 and xDSL and USV DSP 508. Controller 218 operates in a manner similar to that described above with respect to FIG. 2 and chooses DSP coefficients to achieve the correctly filtered signals to achieve separation of the various types of signals. In this example a combined xDSL and USV signal is transmitted and received to/from loop 112 by xDSL and USV D/A 504 and xDSL and USVA/D 510.. xDSL and USV A/D 510 and xDSL and USV D/A 504 convert full bandwidth signals including xDSL and USV signals between the analog and digital domains. The DSPs 508 and 502 do the filtering, shaping, separating, and combining of the signals via control commands from controller 218.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modification, equivalents and alternatives falling within the spirit and scope of the invention as defined by the following appended claims.

What is claimed is:

1. A line card for a telecommunication system, comprising:
a multiple mode circuit that supports a plurality of telecommunications services including xDSL telecommunication service, ISDN telecommunication service, and POTS service.

2. The line card of claim 1, wherein the multiple mode circuit comprises:
a first interface that supports xDSL service.

3. The line card of claim 2, wherein the first interface supports at least one of asymmetric digital subscriber line service, asymmetric digital subscriber line lite service, and very high bit rate digital subscriber line service.

4. The line card of claim 2, wherein the multiple mode circuit supports the xDSL service substantially concomitant with at least one of the POTS service and the ISDN service.

5. The line card of claim 2, wherein the multiple mode circuit comprises:
a second interface that supports at least one of the ISDN telecommunication service and the POTS service.

6. The line card of claim 5, wherein the second interface supports at least one of 2B1Q ISDN service and 4B3T ISDN service.

7. The line card of claim 5, wherein the second interface supports POTS with PPM service.

8. The line card of claim 7, wherein the second interface supports at least one of 12 kHz PPM service and 16 kHz PPM service.

9. The line card of claim 1, wherein the plurality of telecommunications services includes P-Phone service.

10. The line card of claim 1, wherein the plurality of telecommunication services includes DAML service.

11. The line card of claim 1, wherein the multiple mode circuit comprises:
an automatic mode circuit that configures the multiple mode circuit.

12. The line card of claim 11, wherein the automatic mode circuit configures the multiple mode circuit to operate a combination of the plurality of telecommunication services.

13. The line card of claim 12, wherein the automatic mode circuit comprises:
a controller that receives instructions with regard to the plurality of telecommunication services and controls the multiple mode circuit in accordance with the instructions.

14. The line card of claim 13, wherein the controller receives the instructions from an external device, wherein the external device comprises one of a broad band element management system, a PSTN switch, and a PSTN maintenance center.

15. The line card of claim 14, wherein the controller is capable of changing the configuration during a communication session.

16. The line card of claim 15, wherein the controller changes the configuration during a communication session based on information received via a handshake signal.

17. A line card for a telecommunication system, comprising:
a multiple mode circuit that supports a plurality of telecommunication services including xDSL telecommunication service, POTS service, and POTS with PPM service.

18. The line card of claim 17, wherein the PPM service is any one of 12 kHz PPM service and 16 kHz PPM service.

19. The line card of claim 17, wherein the multiple mode circuit further comprises:
a first interface that supports xDSL service.

20. The line card of claim 19, wherein the multiple mode circuit supports the xDSL service substantially concomitant with one of the POTS service and the POTS with PPM service.

21. The line card of claim 19, wherein the first interface supports any one of asymmetric digital subscriber line service, asymmetric digital subscriber line lite service, and very high bit rate digital subscriber line service.

22. The line card of claim 19, wherein the multiple mode circuit comprises:
a second interface that supports the POTS service and the POTS with PPM service.

23. The line card of claim 17, wherein the multiple mode circuit supports ISDN service.

24. The line card of claim 23, wherein multiple mode circuit supports any one of 2B1Q ISDN service and 4B3T ISDN service.

25. The line card of claim 23, wherein the multiple mode circuit supports the ISDN service substantially concomitant with the xDSL digital subscriber line services.

26. The line card of claim 17, wherein the multiple mode circuit supports P phone service.

27. The line card of claim 17, wherein the multiple mode circuit comprises:
an automatic mode circuit that configures the multiple mode circuit.

28. The line card of claim 27, wherein the automatic mode circuit configures the multiple mode circuit to operate a combination of the plurality of telecommunication services.

29. The line card of claim 28, wherein the automatic mode circuit comprises:
a controller that receives instructions with regard to the plurality of telecommunication services and controls the multiple mode circuit in accordance with the instructions.

30. The line card of claim 29, wherein the controller receives the instructions from an external device.

31. The line card of claim 30, wherein the controller is capable of changing the configuration during a communication session.

32. The line card of claim 31, wherein the controller changes the configuration during a communication session based on information received via a handshake signal.

33. A line card for a telecommunication system, comprising:
a multiple mode circuit that supports xDSL telecommunication service, ISDN telecommunication service, POTS telecommunication service, and POTS with PPM telecommunication service.

34. The line card of claim 33, wherein the multiple mode circuit is capable of concomitant operation of the xDSL telecommunication service and the POTS telecommunication service.

35. The line card of claim 33, wherein the multiple mode circuit further supports underlying P phone service.

36. The line card of claim 33, wherein the multiple mode circuit further supports DAML service.

37. The line card of claim 33, wherein the multiple mode circuit is capable of concomitant operation of the xDSL telecommunication service and the POTS with PPM telecommunication service.

38. The line card of claim 33, wherein the POTS with PPM telecommunication service comprises any one of POTS with 12 kHz PPM service and 16 kHz PPM service.

39. The line card of claim 33, wherein the multiple mode circuit is capable of concomitant operation of the xDSL telecommunication service and the ISDN telecommunication service.

40. The line card of claim 33, wherein the ISDN telecommunication service comprises one of 2B1Q ISDN service and 4B3T ISDN service.

41. The line card of claim 33, wherein the xDSL telecommunication services comprise one of asymmetric digital subscriber line service, asymmetric digital subscriber line lite service, and very high bit rate digital subscriber line service.

42. A method for supporting multiple telecommunication services in a line card comprising the steps of:
selecting either a first operational mode or a second operational mode for the line card, wherein the first operational mode provides substantial concomitant operation of xDSL telecommunication service and POTS service, and the second operational mode provides substantial concomitant operation of xDSL telecommunication service and POTS with PPM service;
if the first operational mode is selected, separating xDSL telecommunication signals and POTS signals, and processing the xDSL telecommunication signals and the POTS signals;
if the second operational mode is selected, separating xDSL telecommunication signals and POTS with PPM signals and processing the xDSL telecommunication signals and the POTS with PPM signals.

43. The method of claim 42, wherein the step of selecting comprises the step of:
receiving instructions from an external device regarding which operational mode to select.

44. The method of claim 43, wherein the step of receiving instructions comprises the step of:
receiving the instructions in a handshake signal.

45. The method of claim 42, wherein the step of selecting comprises:
monitoring operation of the line card; and
selecting an operational mode based on operation of the line card.

46. The method of claim 42, wherein the xDSL telecommunication service comprises any one of asymmetric digital subscriber line service, asymmetric digital subscriber line lite service, and very high bit rate digital subscriber line service.

47. The method of claim 42, wherein the POTS with PPM telecommunication service comprises any one of POTS with 12 kHz PPM service and POTS with 16 kHz PPM service.

48. A method for supporting multiple telecommunication services in a line card comprising the steps of:
selecting either a first operational mode or a second operational mode, wherein the first operational mode provides support for substantial concomitant operation of xDSL telecommunication service and POTS service, and the second operational mode provides support for substantial concomitant operation of xDSL telecommunication service and ISDN telecommunication service;
if the first operational mode is selected, separating xDSL telecommunication signals and POTS signals and processing the xDSL telecommunication signals and the POTS signals; and
if the second operational mode is selected, separating xDSL telecommunication signals and ISDN signals and processing the xDSL telecommunication signals and the ISDN signals.

49. The method of claim 48, wherein the step of selecting comprises the step of:
receiving instructions from an external device regarding an operational mode to select.

50. The method of claim 49, wherein the step of receiving instructions comprises the step of:
receiving the instructions in a handshake signal.

51. The method of claim 48, wherein the step of selecting comprises:
monitoring operation of the line card; and
selecting an operational mode based on operation of the line card.

52. The method of claim 48, wherein the xDSL telecommunication service comprises any one of asymmetric digital subscriber line service, asymmetric digital subscriber line lite service, and very high bit rate digital subscriber line service.

53. The method of claim 48, wherein the ISDN telecommunication services comprises any one of 2B1Q and 4B3T ISDN telecommunication services.

54. A line card, comprising:
a first interface that supports a plurality of xDSL telecommunication services;
a second interface that supports a plurality of underlying services (USVs); and
a controller that configures the first interface for one of the plurality of xDSL telecommunication services and configures the second interface for one of the plurality of USVs.

55. The line card of claim 54, wherein the first interface supports asymmetric digital subscriber line service, asymmetric digital subscriber line lite service, and very high bit rate digital subscriber line service.

56. The line card of claim 54, wherein the second interface supports ISDN telecommunication service, POTS service, Periodic Pulse Metering (PPM) service, P-Phone service, and Digital Added Mainline (DAML) service.

57. The line card of claim 56, wherein the second interface supports one of 4B3T ISDN service and 2B1Q ISDN service.

58. The line card of claim 56, wherein the second interface supports one of 12 kHz PPM service and 16 kHz PPM service.
